(19) United States
(12) Patent Application Publication
(10) Pub. No.: US 2015/0082967 A1
(43) Pub. Date: Mar. 26, 2015

(54) DRUM SILENCER

(71) Applicant: ROLAND CORPORATION, SHIZUOKA (JP)

(72) Inventor: KIYOSHI YOSHINO, SHIZUOKA (JP)

(21) Appl. No.: 14/315,291

(22) Filed: Jun. 25, 2014

(30) Foreign Application Priority Data
Sep. 26, 2013 (JP) 2013-200295

(51) Int. Cl. G10D 13/02

(52) U.S. Cl. CPC G10D 13/022
USPC 84/411 M

(57) ABSTRACT

A drum silencer is adapted to be attached to an acoustic drum and to be struck in place of a drumhead of the acoustic drum for reducing a sound generated during performance. The drum silencer includes: a struck body that includes a struck head portion having predetermined elasticity to be struck by a performer, and an annular frame portion supporting a circumferential portion of the struck head portion and having higher rigidity than the struck head portion; and a sucker member that is attached to the frame portion of the struck body and sucks the struck body onto the drumhead.

### CROSS-REFERENCE TO RELATED APPLICATION

This application claims the priority benefit of Japan application serial no. 2013-200295, filed on Sep. 26, 2013. The entirety of the above-mentioned patent application is hereby incorporated by reference herein and made a part of this specification.

### BACKGROUND OF THE INVENTION

1. Field of the Invention

The present invention relates to a drum silencer. Particularly, the present invention relates to a drum silencer that is capable of reducing a percussive sound while retaining a specific tone of an acoustic drum.

2. Description of Related Art

A drum silencer is known to reduce a sound generated during performance in an environment where there is a need to avoid playing at high volume. Patent Literature 1 discloses a drum silencer, for example. According to Patent Literature 1, a silencer pad, fixed to a hoop and in close contact with a drumhead of a bass drum, is struck with a beater. In this way, vibration of the drumhead that occurs with the striking is attenuated early to reduce the percussive sound.

However, the traditional drum silencer, as mentioned above, achieves reduction of the percussive sound by placing the silencer pad fixed to the hoop in close contact with the drumhead so as to attenuate the vibration of the drumhead early. In such a case, free vibration of the drumhead is hindered, which impairs the specific tone of the acoustic drum. As a result, the traditional drum silencer faces the problem that the tone generated by striking the silencer pad differs significantly from the tone generated by directly striking the drumhead.

### PRIOR ART LITERATURE

### Patent Literature

[Patent Literature 1] US Patent Publication No. 2008/0264233 (FIG. 1, etc.)

### SUMMARY OF THE INVENTION

In view of the above, the present invention provides a drum silencer that is capable of reducing a percussive sound while retaining a specific tone of an acoustic drum.

The drum silencer of the present invention achieves the following effects. In a struck body, a struck head portion supported by a frame portion has predetermined elasticity. Thus, a percussive sound generated by striking the struck head portion with a beater, a stick, or the like can be reduced.

In addition, the struck body is sucked to a drumhead by a sucker member. Therefore, the drumhead can vibrate with the struck body through sucker member. Accordingly, the vibration of the struck body that is struck can be transmitted to the drumhead, and hindrance to free vibration of the drumhead due to the striking can be suppressed.

Further, the struck body is attached to the drumhead by a suction force provided by the sucker member. Therefore, in comparison with the case where the entire struck body is in close contact with the drumhead, a contact area between the struck body and the drumhead in the present invention can be suppressed. Hence, hindrance to free vibration of the drumhead, resulting from contact with the sucker member, can be reduced.

Accordingly, hindrance to free vibration of the drumhead can be suppressed while the percussive sound is reduced. In other words, a tone specific to the acoustic drum can be retained.

According to another aspect of the present invention, in addition to the aforementioned effects, the drum silencer further achieves the following effects. Three or more sucker members are disposed along a circumferential direction of the frame portion. Thus, the struck body can be stably sucked to the drumhead. Therefore, when the struck body is struck, the struck body can be prevented from tilting to touch the drumhead.

According to another aspect of the present invention, in addition to the aforementioned effects, the drum silencer further achieves the following effects. The frame portion is formed of a resin material. In comparison with using a metal material to form the frame portion, the frame portion of the present invention can be made lighter. Accordingly, the struck body can be made lighter. Thus, attenuation of the vibration of the drumhead, caused by the weight of the struck body, can be suppressed. Hence, the tone specific to the acoustic drum can be retained when the struck body is struck.

According to another aspect of the present invention, in addition to the aforementioned effects, the drum silencer further achieves the following effects. The struck head portion is formed of a mesh material. Thus, the struck head portion can be made lighter.

Moreover, the impact that occurs when the struck head portion is struck can be buffered. As a result, the percussive sound generated by the striking of the struck body can be reduced.

According to another aspect of the present invention, in addition to the aforementioned effects, the drum silencer further achieves the following effects. In the struck body, the frame portion is fixed to the circumferential portion of the struck head portion by insert-molding the struck head portion in the resin material forming the frame portion. Thus, a mechanism for fixing the struck head portion to the frame portion can be omitted. As a result, the struck body can be made lighter.

According to another aspect of the present invention, in addition to the aforementioned effects, the drum silencer further achieves the following effects. The struck body is fixed to the frame portion while tension is applied on the struck head portion. Thus, the beater, stick, or the like can be pushed back by a restoring force of the struck head portion when the struck head portion is struck and pressed by the beater, stick, or the like. In this way, the feel of striking the struck body can be similar to the striking feeling of striking the drumhead.

According to another aspect of the present invention, in addition to the aforementioned effects, the drum silencer further achieves the following effects. A buffer body, formed of an elastic material and thicker than the struck head portion, is attached to the struck head portion. Thus, when the struck head portion is struck by the beater or the like installed on a foot pedal with a large force, the impact transmitted from the struck body to the drumhead can be reduced. Hence, the percussive sound generated by the striking of the struck body can be reduced.

According to another aspect of the present invention, in addition to the aforementioned effects, the drum silencer further achieves the following effects. The sucker member is connected with the frame portion through an elastic member. Therefore, the impact transmitted from the struck body to the drumhead can be reduced. Hence, the percussive sound generated by the striking of the struck body can be reduced.

### BRIEF DESCRIPTION OF THE DRAWINGS

FIG. 1 is a schematic perspective view of a bass drum with a drum silencer attached thereon according to the first embodiment of the present invention.

FIG. 2A is a schematic top view of the drum silencer.

FIG. 2B is a schematic bottom view of the drum silencer.

FIG. 3 is a schematic cross-sectional view of the drum silencer along the line III-III of FIG. 2A.

FIG. 4 is a schematic perspective view of a snare drum with a drum silencer attached thereon according to the second embodiment.

FIG. 5A is a schematic top view of the drum silencer.

FIG. 5B is a schematic cross-sectional view of the drum silencer along the line Vb-Vb of FIG. 5A.

FIG. 6A is a schematic top view of a drum silencer according to the third embodiment.

FIG. 6B is a schematic cross-sectional view of the drum silencer along the line VIb-VIb of FIG. 6A.

FIG. 7A is a schematic bottom view of the drum silencer.

FIG. 7B is a partially enlarged view of the VIIb section of the drum silencer of FIG. 7A.

### DESCRIPTION OF THE EMBODIMENTS

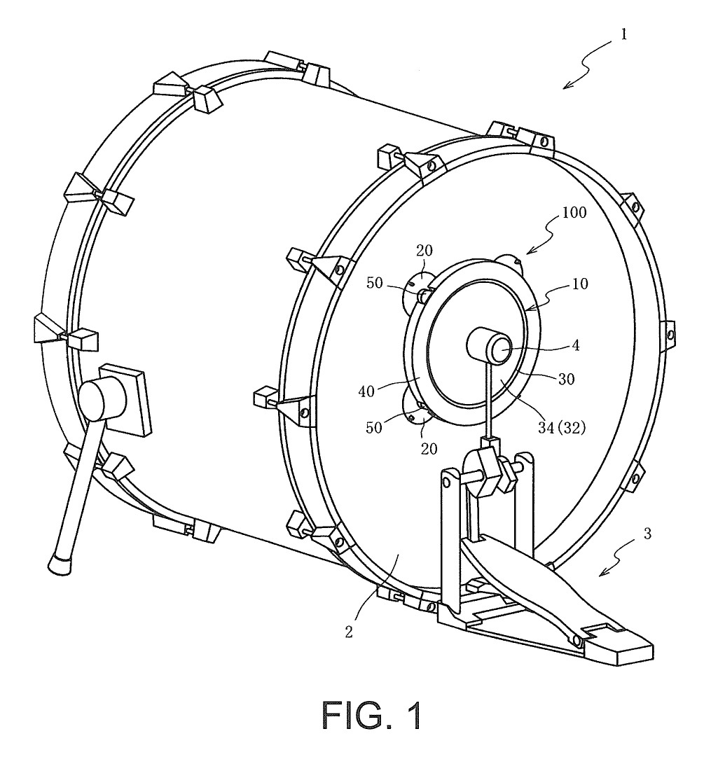

Below exemplary embodiments of the present invention are described in detail with reference to the affixed figures. First, a usage example of a drum silencer 100 according to the first embodiment of the present invention is described with reference to FIG. 1. FIG. 1 is a schematic perspective view of a bass drum 1 with the drum silencer 100 attached thereon according to the first embodiment.

As shown in FIG. 1, the bass drum 1 is an acoustic percussion instrument that includes a drumhead 2 serving as a struck head. The bass drum 1 can generate a tone specific to the bass drum 1 when the drumhead 2 is struck by a beater 4 that rotates with a stamp on a foot pedal 3.

The drum silencer 100 is a device adapted to be attached to the drumhead 2 for reducing the sound generated during the performance. The drum silencer 100 mainly includes a struck body 10 and sucker members 20. The struck body 10 buffers the impact caused by the striking. The sucker members 20 suck the struck body 10 onto the drumhead 2.

The struck body 10 of the drum silencer 100 is sucked to the drumhead 2 by the sucker members 20. When the foot pedal 3 is stamped by the performer, the beater 4 rotates with the stamp to strike the struck body 10.

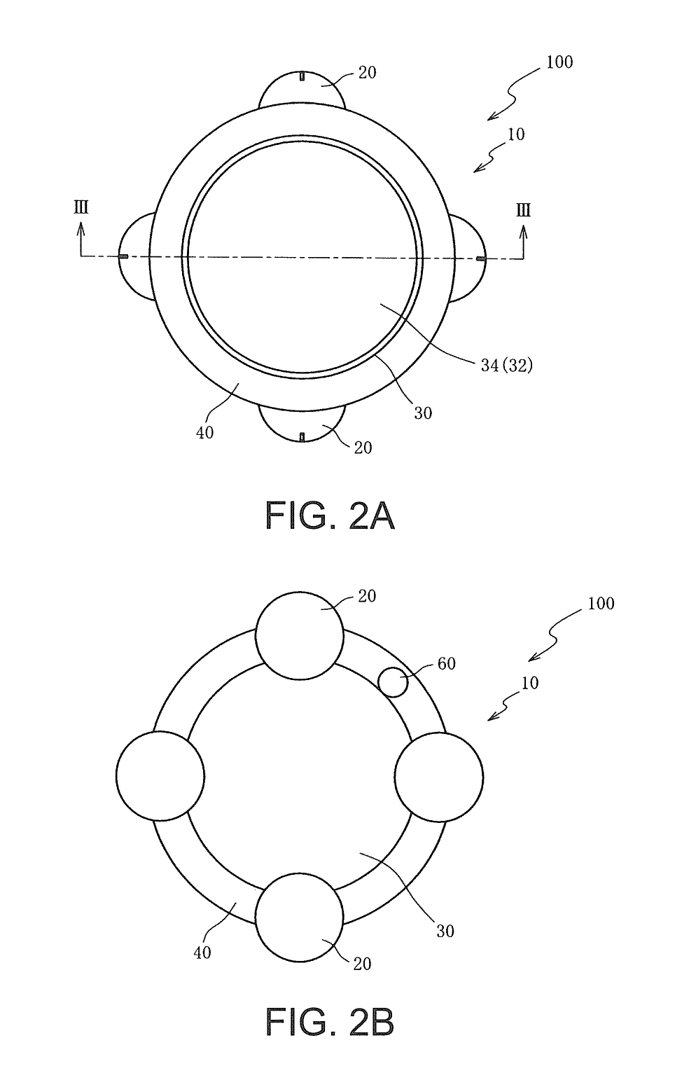

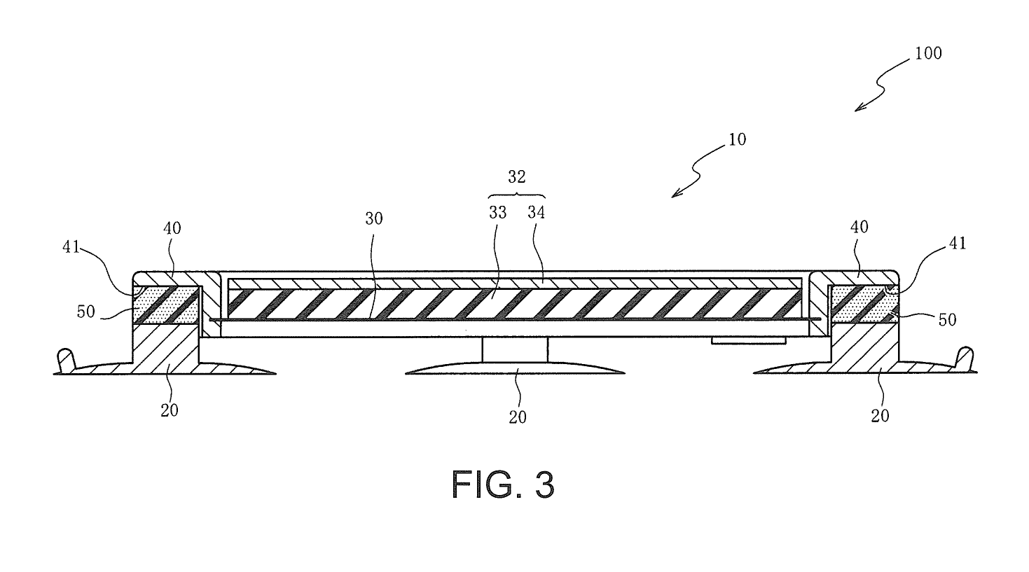

Next, the drum silencer 100 is described with reference to FIG. 2A, FIG. 2B and FIG. 3. FIG. 2A is a schematic top view of the drum silencer 100. FIG. 2B is a schematic bottom view of the drum silencer 100. FIG. 3 is a schematic cross-sectional view of the drum silencer 100 along the line III-III of FIG. 2A.

As shown in FIG. 2A, FIG. 2B or FIG. 3, the struck body 10 mainly includes a struck head portion 30 and a frame portion 40. The struck head portion 30 constitutes the struck head that is to be struck by the performer. The frame portion 40 supports a circumferential portion of the struck head portion 30.

The struck head portion 30 is a membranous portion formed of a stretchable mesh material. By forming the struck head portion 30 using the stretchable mesh material, the struck head portion 30 can be made lighter. In addition, the struck head portion 30 is capable of buffering the impact of the struck head portion 30 when the struck head portion 30 is struck by the beater 4 (see FIG. 1).

Because the struck head portion 30 is formed of the stretchable mesh material, when the struck head portion 30 is pressed and deformed by the striking of the beater 4, a restoring force of the struck head portion 30 can be utilized to push back the beater 4. Therefore, the performer can get a feel approximating to the striking feeling of striking the drumhead 2 directly (see FIG. 1).

Here, a buffer body 32 thicker than the struck head portion 30 is attached to a surface side (the paper front side of FIG. 2A) of the struck head portion 30 of the struck body 10.

The buffer body 32 includes a cushion portion 33 and a hard body 34. The cushion portion 33 is made of a spongy material and is attached to said surface side of the struck head portion 30. The hard body 34 is connected with the cushion portion 33 on a surface (the upper side of FIG. 3) opposite to a surface (the lower side of FIG. 3) to which the struck head portion 30 is attached. In addition, the hard body 34 is made of a hard material harder than the cushion portion 33.

Preferably, the material of the hard body 34 is harder and has higher abrasion resistance than the cushion portion 33 and may be woven or non-woven fabric, for example.

Here, when the struck head portion 30 is struck by the beater 4 that rotates with the stamp on the foot pedal 3, large impact is applied to the struck head portion 30. The large impact is transmitted to the drumhead 2 through the sucker members 20. The result is that the sound generated by the vibration of the drumhead 2 increases. Moreover, due to the vibration of the drumhead 2, the sucker members 20 may be detached from the drumhead 2 easily.

In contrast to the above, by disposing the buffer body 32 at a position corresponding to a position struck by the beater 4, the impact applied to the struck head portion 30 when the beater 4 strikes the struck head portion 30 can be buffered by the cushion portion 33. Thus, the sound generated by the vibration of the drumhead 2 can be reduced. In addition, detachment of the sucker members 20 from the drumhead 2 can also be prevented.

Besides, the foot pedal 3 is usually used in a state of being fixed to the bass drum 1. Therefore, a striking position on the struck body 10 which is struck by the beater 4 held by the foot pedal 3 is substantially consistent. For this reason, if the struck head portion 30 does not have the buffer body 32 attached thereon, the impact caused by the striking of the beater 4 may be concentrated on a portion of the struck head portion 30 when the struck head portion 30 is struck by the beater 4. Hence, only the mesh material, located at the portion of the struck head portion 30 where the striking is concentrated, becomes easily extended. In other words, the durability of the struck head portion 30 is reduced.
In contrast, the buffer body 32 is attached to the struck head portion 30 of the struck body 10. Hence, the impact applied to the struck head portion 30 can be dispersed. Consequently, the durability of the struck head portion 30 is improved.

Furthermore, in the state that the drum silencer 100 is installed to the drumhead 2, the hard body 34 is disposed facing the beater 4 to be struck by the beater 4 during the performance.

Therefore, the beater 4 can be prevented from sinking deep into the buffer body 32. Accordingly, a sag in the cushion portion 33 can be suppressed. The restoring force of the struck head portion 30 can also be utilized easily. As a result, the feel approximating to the striking feeling of actually striking the drumhead 2 can be obtained. The hard body 34 connected with the cushion portion 33 is struck. Accordingly, abrasion of the cushion portion 33, resulting from direct striking on the cushion portion 33, can be prevented.

Further, the buffer body 32 is attached to the struck head portion 30 and the hard body 34 of the buffer body 32 is struck by the beater 4. Accordingly, a collision due to the striking can be buffered by the cushion portion 33 connected with the hard body 34 and the struck head portion 30 to which the cushion portion 33 is attached. Thus, in comparison with directly striking on the struck head portion 30, the drum silencer 100 of the present invention can further reduce the sound (attack noise) generated by the striking.

The frame portion 40 is an annular member formed of a resin material. By forming the frame portion 40 using the resin material, the frame portion 40 can be made lighter in comparison with using a metal material to form the frame portion 40.

Here, in the struck body 10, the frame portion 40 is fixed to the circumferential portion of the struck head portion 30 by insert-molding the struck head portion 30 in which tension is applied to the resin material that forms the frame portion 40.

Thus, a mechanism for fixing the struck head portion 30 to the frame portion 40 can be omitted. The mechanism refers to a tension bolt for connecting the struck head portion 30 and the frame portion 40, and an internal thread structure for screwing the tension bolt, etc. Accordingly, the struck body 10 can be made lighter.

Moreover, the struck head portion 30 is fixed to the frame portion 40 with tension applied thereon. Thus, the beater 4 can be pushed back by the restoring force of the struck head portion 30 that is struck and pressed by the beater 4. In this way, the feel of striking the struck body 10 can be similar to the striking feeling of striking the drumhead 2.

A vibration sensor 60, formed of a piezoelectric actuator, is disposed to adhere to a lower surface side (the paper front side of FIG. 2B) of the frame portion 40. Therefore, with the drum silencer 100 installed to the bass drum 1, the bass drum 1 can be used as an electronic drum.

Further, recesses 41, adapted for accommodating elastic members 50 that are described later, are formed at four positions along a circumferential direction on the lower surface side (the lower side of FIG. 3) of the frame portion 40.

The sucker members 20 are suckers for sucking the struck body 10 onto the drumhead 2 (see FIG. 1). The sucker members 20 are respectively connected with the recesses 41 formed in the frame portion 40 through the elastic members 50.

Here, in this embodiment, four sucker members 20 are disposed on the frame portion 40. However, three or fewer or five or more sucker members 20 may be disposed.

By disposing three or more sucker members 20 along the circumferential direction of the frame portion 40, the struck body 10 can be installed to the drumhead 2 stably. Therefore, when the struck body 10 is struck, the struck body 10 can be prevented from tilting to touch the drumhead 2.

The elastic members 50 are members for buffering the impact transmitted from the struck body 10 to the sucker members 20. The elastic members 50 are respectively formed of a rubbery elastic body. The frame portion 40 and the sucker members 20 are connected through the elastic members 50. Thus, the impact of the struck body 10 that comes with the striking of the beater 4 (see FIG. 1) can be buffered. Accordingly, the impact of the struck body 10 can be suppressed from transmitting to the drumhead 2 by the sucker members 20. Hence, the sound generated by the vibration of the drumhead 2 can be reduced. In addition, detachment of the sucker members 20 from the drumhead 2 can also be prevented.

The struck body 10 is sucked to the drumhead 2 by the sucker members 20. Thus, a negative pressure is utilized to keep the drum silencer 100 and the drumhead 2 in close contact. In this way, the drumhead 2 can vibrate with the struck body 10 while a contact area between the drum silencer 100 and the drumhead 2 is suppressed. Therefore, the vibration of the struck body 10 that is struck can be transmitted to the drumhead 2, and hindrance to free vibration of the drumhead 2 caused by the striking can be suppressed.

In addition, the struck body 10 remains attached to the drumhead 2 due to a suction force provided by the sucker members 20. Therefore, in comparison with the case where the entire struck body 10 is in close contact with the drumhead 2, the contact area between the struck body 10 and the drumhead 2 in the present invention can be suppressed. Hence, hindrance to free vibration of the drumhead, resulting from contact with the sucker members 20, can be suppressed.

Furthermore, the struck head portion 30 is formed of the mesh material and the frame portion 40 is formed of the resin material, and the struck head portion 30 and the frame portion 40 are formed integrally by insert-molding. Thus, the struck body 10 can be made lighter. By doing so, attenuation of the vibration of the drumhead 2, caused by the weight of the struck body 10, can be suppressed. Hence, hindrance to free vibration of the drumhead 2 can also be suppressed. In other words, when the struck body 10 is struck, the tone specific to the bass drum 1 can be retained.

Besides, the impact of the struck body 10 that comes with the striking of the beater 4 can be buffered by the struck head portion 30, the cushion portion 33, and the elastic members 50. Therefore, the impact transmitted to the drumhead 2 through the sucker members 20 can be reduced. Accordingly, the volume of the tone generated by the vibration of the drumhead 2 can be lowered. Further, a collision sound (attack noise) that occurs when the struck body 10 is struck can be reduced. Accordingly, cancellation of the tone generated by the vibration of the drumhead 2 due to the collision sound can be suppressed.

Like this, the volume of the tone that occurs with the vibration of the drumhead 2 can be lowered and the collision sound that comes with the striking of the struck head portion 30 can be reduced. Accordingly, the tone specific to the bass drum 1 can be brought out. In other words, a sound approximating to the tone generated by directly striking the drumhead 2 can be produced predominantly.

Moreover, the struck body 10 and the drumhead 2 are connected through the sucker members 20. Therefore, in comparison with the case where the struck body 10 and the drumhead 2 are attached by using an adhesive tape, etc., a process of attaching and detaching the struck body 10 can be simplified. Further, in comparison with the case where the struck body 10 is connected with the bass drum 1 with use of a bolt, etc., the process of attaching and detaching the struck body 10 can be simplified.

The second embodiment is explained hereinafter. The first embodiment illustrates a situation where the buffer body 32 is attached to the struck head portion 30, and the frame portion 40 and the sucker members 20 are connected through the elastic members 50. In the second embodiment, however, the buffer body 32 is omitted. In addition, in the second embodiment, the frame portion 40 and sucker members 220 are connected directly. The same reference numerals are used to denote components the same as the previous embodiment. Thus, detailed descriptions thereof are not repeated hereinafter.

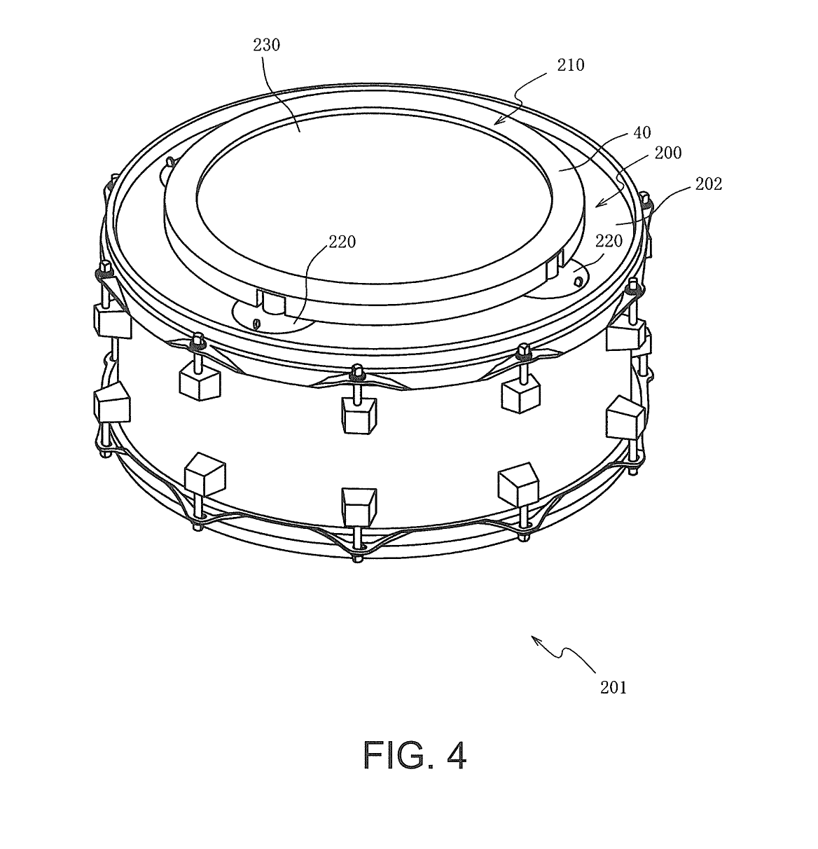

First, a usage example of a drum silencer 200 according to the second embodiment is described with reference to FIG. 4. FIG. 4 is a schematic perspective view of a snare drum 201 with the drum silencer 200 attached thereon according to the second embodiment.

As shown in FIG. 4, the snare drum 201 is an acoustic percussion instrument adapted to be struck with a stick, etc. The snare drum 201 can generate a tone specific to the snare drum 201 by striking a drumhead 202 with a stick, etc.

The drum silencer 200 is a device adapted to be attached to the drumhead 202 for reducing the percussive sound generated during the performance. The drum silencer 200 mainly includes a struck body 210 and sucker members 220.

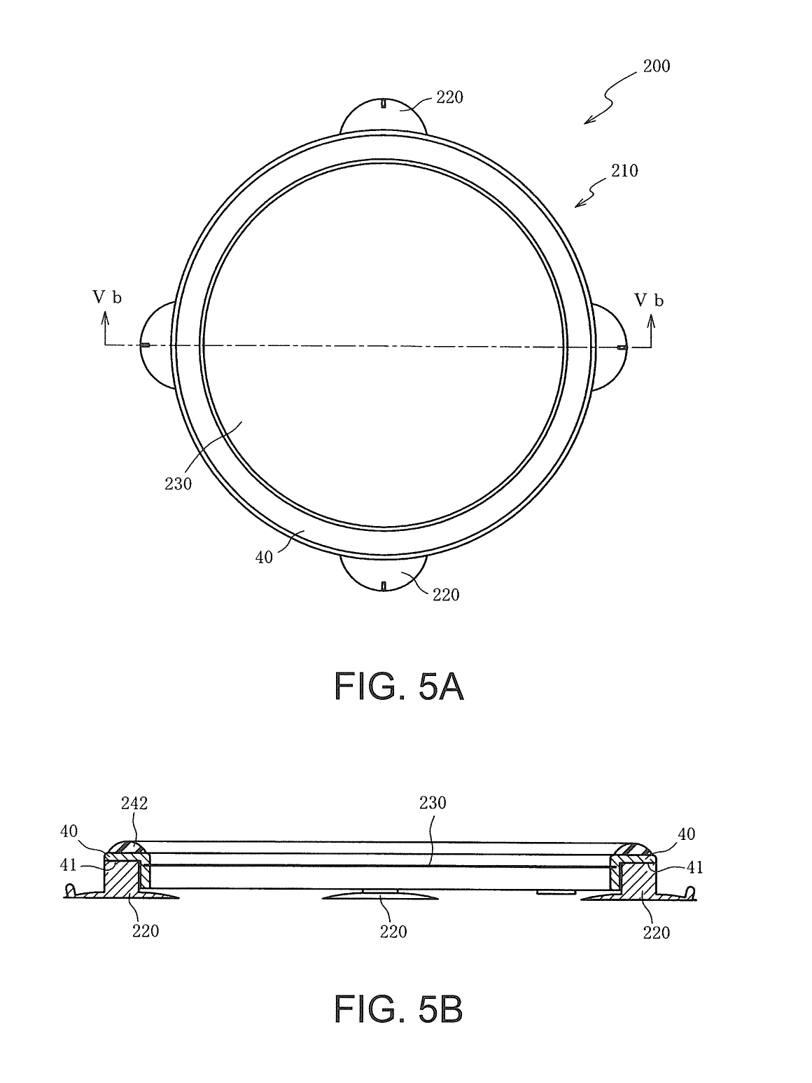

Next, a detailed configuration of the drum silencer 200 is described with reference to FIG. 5A and FIG. 5B. FIG. 5A is a schematic top view of the drum silencer 200. FIG. 5B is a schematic cross-sectional view of the drum silencer 200 along the line Vb-Vb of FIG. 5A.

As shown in FIG. 5A and FIG. 5B, the drum silencer 200 includes a struck head portion 230 and the frame portion 40. The struck head portion 230 and the frame portion 40 are formed integrally by insert-molding. In addition, the sucker members 220 are directly connected with the recesses 41 of the frame portion 40. Further, an annular rim portion 242, formed of a rubbery elastic body, is attached to the upper surface side of the frame portion 40 (the upper side of FIG. 5B).

The rim portion 242 is a portion adapted to be struck when the performer performs a rim shot. By striking the rim portion 242 during the rim shot, the generated sound (attack noise) can be reduced.

Here, the drum silencer 100 (see FIG. 1) of the first embodiment is installed on the bass drum 1 that is struck by the beater 4 rotating with the stamp on the foot pedal 3. Moreover, in the drum silencer 100 (see FIG. 2A, FIG. 2B, and FIG. 3) of the first embodiment, the buffer body 32 including the cushion portion 33 and the elastic members 50 are disposed, besides the struck head portion 30 formed of the mesh material, to serve as the configuration for buffering the impact on the struck body 10. On the other hand, in comparison with the drum silencer 100 of the first embodiment, the impact and vibration applied to the drumhead 202 of the snare drum 201 that is struck by the stick are smaller. For this reason, if the drum silencer 100 of the first embodiment is installed to the snare drum 201, the vibration of the struck body 10 may be attenuated excessively and may not be sufficiently transmitted to the drumhead 202. In other words, the specific tone of the snare drum may hardly be produced.

In contrast to the drum silencer 100 of the first embodiment, in the drum silencer 200 of the second embodiment, the buffer body 32 and the elastic members 50 are omitted, and the impact applied on the struck body 210 is attenuated by the struck head portion 30. Therefore, while the impact of the striking is suppressed from transmitting from the struck body 210 to the drumhead 202, the vibration of the struck body 210 can be easily transmitted to the drumhead 202.

In addition, by omitting the buffer body 32 and the elastic members 50, the struck body 210 can be made lighter correspondingly. Thus, attenuation of the vibration of the drumhead 202, caused by the weight of the struck body 210, can be suppressed. Hence, hindrance to free vibration of the drumhead 202 can also be suppressed. Therefore, when the struck body 210 is struck, the tone specific to the snare drum 201 can be retained.

The vibration sensor 60 may also be disposed to adhere to the lower surface side (the lower side of FIG. 5B) of the frame portion 40. With the drum silencer 200, provided with the vibration sensor 60, attached to the snare drum 201, the snare drum 201 can be used as an electronic drum.

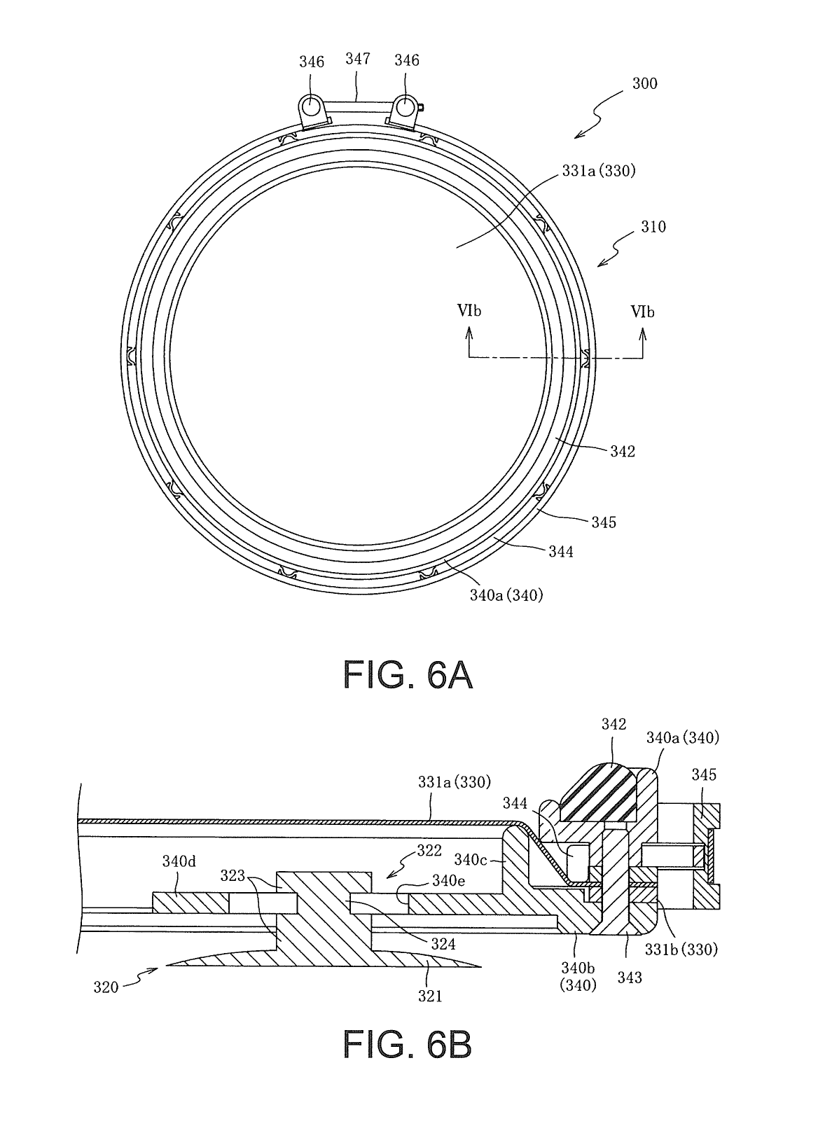

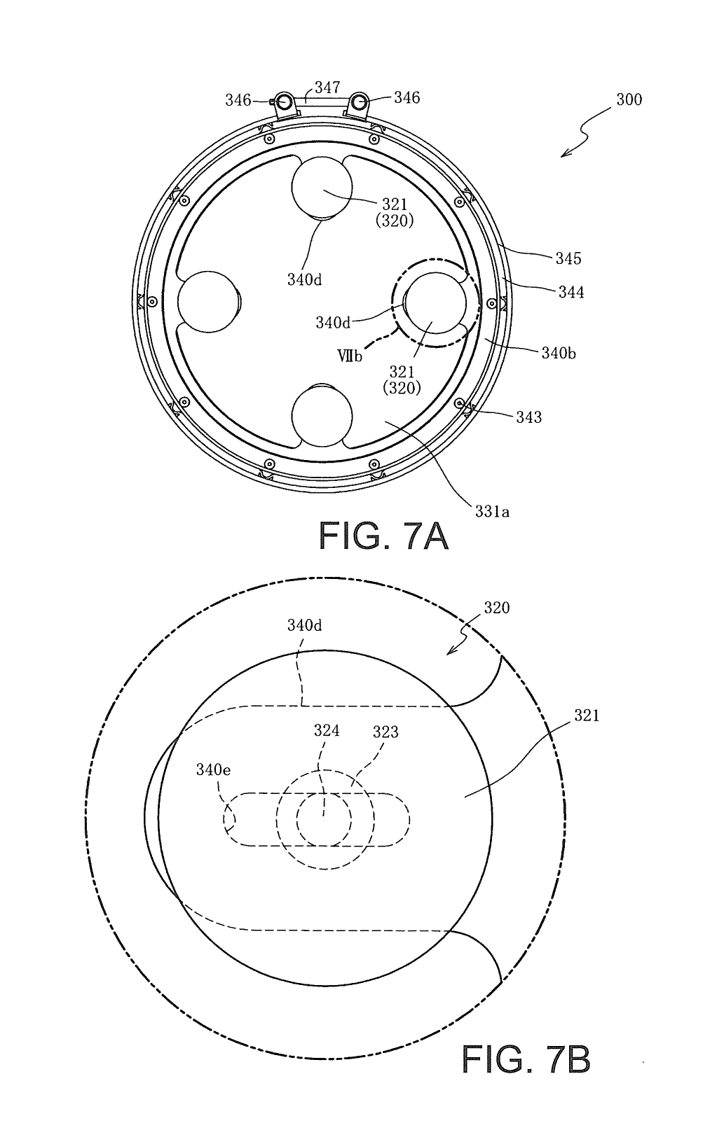

Hereinafter, the third embodiment is described with reference to FIG. 6A, FIG. 6B, FIG. 7A, and FIG. 7B. The first and the second embodiments illustrate a situation where the struck head portions 30 and 230 are formed integrally with the frame portion 40 by insert-molding. In the third embodiment, however, a struck head portion 330 and a frame portion 340 are formed individually. The same reference numerals are used to denote components the same as the previous embodiment. Thus, detailed descriptions thereof are not repeated hereinafter.

FIG. 6A is a schematic top view of a drum silencer 300 according to the third embodiment. FIG. 6B is a schematic cross-sectional view of the drum silencer 300 along the line VIb-VIb of FIG. 6A. FIG. 7A is a schematic bottom view of the drum silencer 300. FIG. 7B is a partially enlarged view of the VIIb section of the drum silencer 300 of FIG. 7A. To simplify the illustration and to make the description more comprehensible, FIG. 7B depicts a part of a sucker member 320, a part of a sucker support portion 340d, and a hole 340e with broken lines.

As shown in FIG. 6A and FIG. 6B, the drum silencer 300 includes a struck body 310 and sucker members 320. The sucker members 320 are detachably connected with the struck body 310. Except the configuration for attaching the sucker members 320 to a lower frame portion 340b that is to be described later, the struck body 310 has the same configuration as the drum previously developed by the applicants of the present invention and filed as a patent application (Japanese Patent Application No. 2013-084682).

The struck body 310 mainly includes a struck head portion 330, a frame portion 340, a fixing bolt 343, a plurality of contact plates 344, and a tension ring 345. The struck head portion 330 includes a membrane portion 331a formed of a stretchable mesh material, and a fixing portion 331b fixed to a circumferential portion of the membrane portion 331a. The frame portion 340 includes an upper frame portion 340a and the lower frame portion 340b that hold the fixing portion 331b. Besides, the frame portion 340 has an annular shape. The fixing bolt 343 is used to fix the fixing portion 331b to the frame portion 340. The contact plates 344 are configured to displace in a radial direction with respect to the frame portion 340. The contact plates 344 apply tension to the membrane portion 331a when being displaced inward in the radial direction. The tension ring 345 is disposed on outer circumferential surfaces of these contact plates 344. Moreover, the tension ring 345 has a shape of an open loop. A rim portion 342, formed of a rubbery elastic body, is attached to an upper surface side of the upper frame portion 340a.

The membrane portion 331a is stretched to be installed on a struck head support portion 340c that protrudes from the lower frame portion 340b. Tension is applied to the membrane portion 331a when the tension ring 345 is tightened.

That is, when a pair of coupling members 346 respectively formed at two end portions of the tension ring 345 along the circumferential direction are screwed and coupled to each other by a connection bolt 347, an inner diameter of the tension ring 345 is shortened. By doing so, the contact plates 344 are pressed by an inner circumferential surface of the tension ring 345 to displace inward in the radial direction. Moreover, the membrane portion 331a is placed on an upper end portion (end portion on the upper side of FIG. 6B) of the struck head support portion 340c. Further, the fixing portion 331b that is fixed to the circumferential portion of the membrane portion 331a is fixed to the frame portion 340. Thus, as the contact plates 344 are displaced inward in the radial direction, a portion of the membrane portion 331a located at an outer circumferential side of the struck head support portion 340c is pulled downward. Accordingly, tension is applied to the membrane portion 331a.

Therefore, by adjusting a tightening amount of the tension ring 345, the tension of the membrane portion 331a can be adjusted properly to obtain the striking feeling the performer prefers.

Here, the sucker support portions 340d, which protrude inward in the radial direction, are formed on the lower frame portion 340b at four positions equally spaced along the circumferential direction of the lower frame portion 340b. The holes 340e having a long circular shape are drilled to penetrate the sucker support portions 340d respectively and extend along the radial direction of the lower frame portion 340b. In addition, the sucker members 320 are respectively locked to the holes 340e.

The sucker member 320 is formed of an elastic material. Moreover, the sucker member 320 is configured to be detachable from the lower frame portion 340b. The sucker member 320 includes a suction portion 321 and a locking portion 322. The suction portion 321 is configured as a sucker for sucking the drumhead 202 (see FIG. 4) of the snare drum 201. The locking portion 322 is connected with a surface of the suction portion 321, which is opposite to a surface by which the suction portion 321 is sucked to the drumhead 202.

The locking portion 322 is a portion locked to the sucker support portion 340d. The locking portion 322 includes large diameter portions 323 and a small diameter portion 324. The large diameter portions 323 are a pair of portions, having a disc shape and facing each other. The small diameter portion 324 connects surfaces of the pair of large diameter portions that face each other. In addition, the small diameter portion 324 has an outer diameter smaller than an outer diameter of the large diameter portion 323. The pair of large diameter portions 323 and the small diameter portion 324 are disposed concentrically to form a substantially H shape (see FIG. 6B).

When installing the sucker member 320 to the lower frame portion 340b, the large diameter portion 323 located on the side opposite to the suction portion 321 with respect to the small diameter portion 324 is pressed into the hole 340e from the lower side (the lower side of FIG. 6B) of the sucker support portion 340d such that the large diameter portion 323 protrudes on the upper surface side of the lower frame portion 340b. Accordingly, the locking portion 322 is locked to the lower frame portion 340b.

Here, an interval between the pair of large diameter portions 323 facing each other is set to be slightly smaller than the thickness of the lower frame portion 340b (dimensions in the vertical direction of FIG. 6B). In addition, the outer diameter of the small diameter portion 324 is set to be slightly larger than the width of the hole 340e (dimensions in the vertical direction of FIG. 7B).

Accordingly, the sucker support portion 340d can be held by the elastically deformed large diameter portions 323. Therefore, the locking portion 322 can be securely fixed to the sucker support portion 340d. Moreover, the small diameter portion 324 can be elastically deformed to be held by the inner circumferential surface of the hole 340e. Therefore, the locking portion 322 can be securely fixed to the sucker support portion 340d.

Further, the hole 340e has the long circular shape with a longitudinal direction consistent with the radial direction of the lower frame portion 340b. Hence, a locking position of the sucker member 320 can be adjusted along the radial direction of the frame portion 340.

Here, the membrane portion 331a is stretched and disposed on the upper end surface of the struck head support portion 340c, and vibratability differs between a central portion of the membrane portion 331a and a portion close to the upper end portion of the struck head support portion 340c. Moreover, by adjusting a suction position of the sucker member 320 in the radial direction of the drumhead 202 (see FIG. 4), a position at which vibration is transmitted from the sucker member 320 to the drumhead 202 when the struck body 310 is struck is changed. As a result, the tone of the snare drum 201 (see FIG. 4) that is generated by the vibration of the drumhead 202 can be varied.

Furthermore, the vibration sensor 60 may also be disposed to adhere to the lower surface side (the lower side of FIG. 6B) of the frame portion 40. With the drum silencer 300, provided with the vibration sensor 60, attached to the snare drum 201, the snare drum 201 can be used as an electronic drum.

The above illustrates the present invention on the basis of the exemplary embodiments. However, it should be understood that the invention is not limited to any of the exemplary embodiments, and various modifications or alterations may be made without departing from the spirit of the present invention.

For example, the above embodiments illustrate a situation of using the drum silencer 100 of the first embodiment on the bass drum 1. Moreover, the drum silencers 200 and 300 of the second and third embodiments are used on the snare drum 201. However, the present invention is not limited thereto. The drum silencer 100 of the first embodiment may also be used on a drum other than the bass drum 1. In addition, the drum silencers 200 and 300 of the second and third embodiments may also be used on a drum other than the snare drum 201.

The first and second embodiments illustrate a situation where the frame portion 40 of the struck body 10 and 210 is fixed to the circumferential portion of the struck head portion 30 formed of the mesh material. However, the present invention is not limited thereto. The frame portion 40 may also be fixed to the circumferential portion of a struck head portion that is formed of a material other than the mesh material, such as a film-like, sponge-like, or rubber-like member, for example.

The above embodiments illustrate a situation where the frame portions 40 and 340 are formed of the resin material. However, the present invention is not limited thereto. The frame portion may be formed using a material other than the resin material, such as a metal material, for example.

What is claimed is:

1. A drum silencer, adapted to be attached to an acoustic drum and to be struck in place of a drumhead of the acoustic drum for reducing a sound generated during performance, the drum silencer comprising:
a struck body comprising a struck head portion that has predetermined elasticity to be struck by a performer, and an annular frame portion that supports a circumferential portion of the struck head portion and has higher rigidity than the struck head portion; and
at least one sucker member attached to the frame portion of the struck body and sucking the struck body onto the drumhead.

2. The drum silencer according to claim 1, wherein the at least one sucker member comprises three or more sucker members disposed along a circumferential direction of the frame portion.

3. The drum silencer according to claim 1, wherein the frame portion of the struck body is formed of a resin material.

4. The drum silencer according to claim 1, wherein the struck head portion is formed of a mesh material.

5. The drum silencer according to claim 1, wherein the frame portion of the struck body is formed of a resin material, the struck head portion is formed of a mesh material, and in the struck body, the frame portion is fixed to the circumferential portion of the struck head portion by insert-molding the struck head portion in the resin material forming the frame portion.

6. The drum silencer according to claim 5, wherein the struck head portion is fixed on the frame portion in a state where tension is applied.

7. The drum silencer according to claim 4, wherein, in the struck body, a buffer body that is formed of an elastic material and thicker than the struck head portion is attached to the struck head portion.

8. The drum silencer according to claim 7, wherein the buffer body comprises:
a cushion portion attached to a surface of the struck head portion; and
a hard body connected with the cushion portion on a surface opposite to the surface attached to the struck head portion.

9. The drum silencer according to claim 1, wherein the at least one sucker member is connected with the frame portion through an elastic member formed of an elastic material.

10. The drum silencer according to claim 9, wherein a plurality of recesses are formed on a lower surface side of the frame portion along the circumferential direction for accommodating the elastic member, and
the at least one sucker member is respectively connected with the plurality of recesses formed in the frame portion through the elastic member.

11. The drum silencer according to claim 1, wherein a vibration sensor is disposed to adhere to a lower surface side of the frame portion.

12. The drum silencer according to claim 1, wherein an annular rim portion formed of a rubbery elastic body is attached to an upper surface side of the frame portion.

13. The drum silencer according to claim 1, wherein the acoustic drum is a bass drum, and the struck body is sucked to a drumhead of the bass drum by the at least one sucker member.

14. The drum silencer according to claim 1, wherein the acoustic drum is a snare drum, and the struck body is sucked to a drumhead of the snare drum by the at least one sucker member.

15. A drum silencer, adapted to be attached to an acoustic drum, the drum silencer comprising:
a struck body comprising a struck head portion that has predetermined elasticity and an annular frame portion that supports a circumferential portion of the struck head portion; and
a plurality of sucker members attached to the frame portion of the struck body and sucking the struck body to a drumhead of the acoustic drum,
wherein the struck body is installed to the drumhead through the plurality of sucker members that are disposed along a circumferential direction of the frame portion.

16. The drum silencer according to claim 15, wherein the plurality of sucker members are connected with the frame portion through an elastic member formed of an elastic material.

17. The drum silencer according to claim 15, wherein the plurality of sucker members are detachably connected with the struck body.

18. The drum silencer according to claim 15, wherein a plurality of sucker support portions are formed on the frame portion of the struck body along the circumferential direction and protrude inward in a radial direction of the frame portion, and
the plurality of sucker members are respectively locked to the plurality of sucker support portions.

19. The drum silencer according to claim 18, wherein a plurality of holes are formed to penetrate the plurality of sucker support portions, and the plurality of sucker members are locked to the plurality of holes.

20. The drum silencer according to claim 19, wherein the hole has a long circular shape that extends in the radial direction of the frame portion.
